(19) United States
(12) Patent Application Publication
(10) Pub. No.: US 2011/0213809 A1
(43) Pub. Date: Sep. 1, 2011

(54) Method, a system and a computer program product for protecting a data-storing device

(75) Inventors: Carlos ARDANZA AZCONDO, Abadiano (ES); Francisco FERNÁNDEZ GUERRA, Bilbao (ES); Iñaki URZAY BASARRATE,, Bilbao (ES)

(73) Assignee: PANDA SECURITY, S.L., Bilbao (ES)

(21) Appl. No.: 12/715,290

(22) Filed: Mar. 1, 2010

(51) Int. Cl. G06F 3/00; G06F 17/30; G06F 21/00

(52) U.S. Cl. 707/802; 710/10; 707/822; 726/26

(57) ABSTRACT

A method for protecting a data-storing device, the method including, when the data-storing device is connected to a first computing system, writing, using the first computing system, data associated to an autorun file within the data-storing device, in such a way that the autorun file is not accessible as such a file by an operating system running in a second computing system.

The present invention relates to a method for protecting a data-storing device. More specifically, the invention relates to a method for avoiding that the Windows “autorun.inf” file in data-storing devices (for example, external storage devices such as USB pendrives) can act as a vector for malware propagation.

The invention also relates to a system and a computer program product for protecting a data-storing device suitable for carrying out such a method.

Preferably, the invention is applied in the field of the computer security and, more specifically, it is directed towards protecting computing systems from becoming infected by any kind of malware.

### BACKGROUND ART

Nowadays, a huge percentage of personal computers (PC) use one of the different versions of Microsoft Windows Operating Systems. Examples of Windows Operating Systems are Windows 95, 98, ME, 2000, XP, Vista and 7.

In order to ease the installation of applications, Microsoft introduced in its family of Windows Operating Systems a feature called “Autorun”. This was done with the launch of Windows 95 in 1995.

Originally the feature allowed that in a properly configured CD-ROM, upon insertion, Windows looks in the media for a special file with plain text in the drive's root directory, called AUTORUN.INF and followed its instructions to run a program.

In the following example the AUTORUN.INF tells Windows to run the program “install.exe” (also located in the root directory of the device) and establishes the icon “clock.ico” as the icon for the device that will be shown to identify the device in Windows Explorer:

[autorun]

open=install.exe

icon=clock.ico

As intended to be used, this would automatically initiate the installation of, for example, a commercial application from a CD-ROM, without the need of any user interaction.

In summary, the Microsoft Windows Operating Systems use the AUTORUN.INF file in order to know which actions to perform when a data-storing device is inserted into or connected to a computing system, such as a personal computer (PC). Data-storing device comprises all types of CD, DVD media but also portable storage devices as External Hard Disk Drives and Pendrives that are connected to computers via interfaces like USB (Universal Serial Bus), IEEE 1394 (a.k.a. Firewire) or similar ones. USB Pendrives are also commonly known by the names USB Flash drives, USB Memory Sticks, USB Thumb Drives and others.

Consequently, the AUTORUN.INF file is a configuration file that is normally located in the root directory of data-storing media and may comprise, among other things, a reference to the icon that will be shown associated to the removable drive or volume, a description of its content and also the possibility to define a program which should be executed automatically when the unit is mounted in the computing system.

However, nowadays there are other ways in which a program that has been specified in an AUTORUN.INF file can be executed in a more or less automated or inadvertent way.

Basically these 4 ways are:

Autorun;

Autoplay;

Execution from a highlighted option from the drive's shortcut menu (accessed with a right-click);

Execution after double clicking on the drive's icon.

This way, Windows Operating Systems provide a variety of ways to handle the AUTORUN.INF file, depending on the various Windows versions which support it and on the configured options. Anyway, there could always exist cases where the AUTORUN.INF located in the root of a data-storing media is parsed and thus an executable can be invoked from it, without user's knowledge.

The existence of computer malware which encompass computer viruses, Trojans, spyware, worms and the like, that plague computers today is also a well-known fact. Malware comprises any malicious executable code intended to infiltrate or harm a computing system (or in other words, computer or computer system) without user's consent.

Nowadays it has become quite common that certain malware uses the Autorun related mechanism to infect computers and spread via data-storing devices and more specifically through USB pendrives or memory sticks, Smart Cards, MP3 Players, mobile telephones, cameras and so on.

Basically, this threat is quite similar to old DOS viruses which spread by infecting the Boot sector in floppy disks. The malware that uses this method of propagation is sometimes called Autorun worms, since it moves from device to device by using, among other ways, their AUTORUN.INF file as part of the propagation mechanism.

Computer worms are defined as malware that includes built-in self-propagation features. In this case the self-propagation mechanism comprises the call to a malicious executable file from an AUTORUN.INF file and the further infection of any new connected data-storing device (e.g. USB drive), by copying the malicious worm executable file to the USB drive and creating an AUTORUN.INF file which calls the worm afterwards. So, after insertion in a clean computer, it is probable that the computer becomes infected. Some examples are the W32/Sality, W32/Virutas and also the W32/Conficker worm which, in addition to spreading via a software vulnerability and network shares, also spreads via USB drives.

Typically a worm marks the AUTORUN.INF file as if it was created with “Hidden” and “System” attributes, to be less detectable by the user. So, a feature intended to ease the installation of new applications has become an important vector for the distribution of malware, mainly due to the ubiquity of data-storing devices (such as USB external storage devices), mainly hard disk drives and Pendrives.

As noted above, Autorun allows an automatic execution of a program called from the AUTORUN.INF file upon insertion of the media in the computer. This basically affects CD-ROM drives, but also any other data-storing device (for example, removable storage devices) like external hard drives which the computer identifies as fixed drives (that is, not marked as a removable media device) may use this feature. Also, other external drive types like USB Flash Pendrives do not Autorun upon connection as standard, because these drives are much more readily infected and transmitted around to other computers. Some Autorun worms may use this mechanism to propagate, although it does not usually work for USB Flash pendrives that are broadly distributed among computer users.

As mentioned earlier also, from Windows XP, there is a related feature called “Autoplay”. Autoplay is a more recent enhancement of Autorun, designed to improve the security model. Instead of the data-storing media deciding by itself which program to execute, the user can make a choice using a displayed AutoPlay Menu. The items that appear on this menu are determined by the type of files found on the drive (such as pictures, music or video), but also by the information found in the AUTORUN.INF file.

It is possible to include in the AUTORUN.INF file one line defining the option to be displayed in the Autoplay menu and the executable which will execute upon clicking. So, by checking the appropriate box in the AutoPlay dialog, running USB Flash drive malware becomes silent and automatic. Some Autorun worms employ this Autoplay menu mechanism to propagate. Since Autoplay is user-controlled and thus somehow “secure”, Windows enables Autoplay to be used with removable drives by default.

However, Windows Vista allows a user to configure the Autoplay settings to automatically run whatever program is specified in the AUTORUN.INF file, which means that an infected USB drive will indeed effectively be permitted to “Autorun”. This can be configured inadvertently when inserting a CD with a legitimate Autorun program, and Vista's Autoplay menu asks the user what he wants to do. One of the options is to run the program, in combination with checking the “always do this” checkbox. If the user does this, the next time he inserts an infected USB drive with an Autorun worm, it will launch the piece of malware automatically. So, the Autoplay mechanism can be a dangerous one.

Also as described above, still there are at least two more ways for an executable file to be executed from the AUTORUN.INF file.

Execution can be performed from a highlighted option from the drive's shortcut menu (accessed with a right-click). The worm writes the AUTORUN.INF file in such a way that clicking on an option will launch the malicious code contained in the external drive.

Execution of the malicious executable stated in the AUTORUN.INF file can also take place after double clicking on the drive's icon, when opened with Windows Explorer.

So, a series of different mechanisms exist in different Windows Operating Systems that allow the spreading of Autorun worms in an automated or almost unnoticed way, making the use of data-storing devices highly risky. It is well demonstrated that this Autorun-related functionality is being used as a vector for malware propagation, due to the easiness of the method for silent malware propagation. This has also been used for instance in rogue CD-ROM which automatically install malware in a computer after its insertion in the drive.

With the advent of the so-called netbooks (small laptop computers mainly intended for Internet use) the usage of USB pendrives has become even more widespread, since they rarely include a CD/DVD player or recorder. This makes the problem of infected pendrives even more relevant than ever.

So, summarizing, USB worms propagate by creating a file called AUTORUN.INF on the root of USB drives and a malicious executable also contained in the same drive is called from it. These files then use any of the four described mechanisms to execute themselves, being the most common method the one where the user double-clicks on the USB drive icon from Windows Explorer.

Most of the solutions which deal with this problem have been designed towards protecting the PC from becoming infected when an infected data-storing device is inserted. These solutions change some Windows Registry Entries in order to disable the AUTORUN.INF functionality in the machine.

One of the most successful methods proposed as a solution is to edit the following Windows Registry Entry:

[HKEY_LOCAL_MACHINE\SOFTWARE\Microsoft\Windows
NT\CurrentVersion\IniFileMapping\Autorun.inf]
@=”@SYS:DoesNotExist”

The practical effect of this is that Windows will treat any AUTORUN.INF file as being empty, so nothing can execute starting from it in any way. This way, worms cannot enter the computer unless the user double clicks directly on the executables. The Autorun code execution scenarios described above will no longer parse the AUTORUN.INF, therefore stopping any malicious intent.

But these solutions, although protecting the computers, do not solve the problem of the infected data-storing device or media. If the infected device is inserted in an unprotected PC afterwards, the likelihood of the unprotected computer to be infected is high.

Although most computers are protected by a state-of-the-art anti-virus or anti-malware application, the big amount of circulating malware nowadays still makes possible that the malicious code is not detected as malware upon insertion of the device and thus the computer may be infected.

So, it is quite clear that it would be beneficial finding a way to avoid data-storing devices to become a carrier or vector for further malware propagation.

Several methods have been proposed so far to deal with this. For example if the user creates a directory on the external drive named “AUTORUN.INF”, then, afterwards, the operating system does not allow to create an AUTORUN.INF file in the root directory of the drive.

Any Autorun worm that may be running in a computer still can write their executable in the inserted drive, but not the AUTORUN.INF file necessary to launch that program in another computer, and therefore spread the infection as described. So, this solution may work for worms which are not aware of this protection mechanism.

Although this is a nice solution, it is quite easy for malware to bypass. Simply deleting any AUTORUN.INF directory is an easy operation for the malware to perform.

### SUMMARY OF THE INVENTION

It is an object of the present invention to provide a method for protecting a data-storing device that allows improving the security of said data-storing device in front of, for example, malware.

To achieve the above, according to a first aspect, the invention provides a method for protecting a data-storing device, the method comprising, when the data-storing device is connected to a first computing system:
Writing, using the first computing system, data associated to an autorun file (for example, a Windows “autorun.inf” file) within the data-storing device, in such a way that said autorun file is not accessible as such a file by an operating system running in a second computing system.

This way, the method of the present invention, for example, avoids that the autorun file in the data-storing device can act as a vector for malware propagation, because the operating system running in the computing system to which the data-storing device is connected cannot access to said autorun file as such a file. Basically, the method shall make more difficult the creation of a malicious autorun file in a data-storing device that has been protected with this method.

Writing determined data associated to the autorun file in the data-storing device does not allow the operating system of the computing system to which the data-storing device is connected accessing to the autorun file as such a file, obtaining a protection of the data-storing device, for example, in front of malware. This way, the obtained protection can avoid, for example, that the Windows “autorun.inf” file in data-storing devices can act as a vector for malware propagation, because, after the method of the invention is applied to the data-storing device, the “autorun.inf” file cannot be accessed by the operating system and, consequently, said file cannot be, for example, deleted, removed or renamed or a new “autorun.inf” file cannot be created. Thus, the method of the invention shall make much more difficult the creation of a malicious autorun file in a data-storing device that has been protected with this method.

Consequently, with this method, a strong way of avoiding malware to propagate through data-storing devices, like the ubiquitous USB Flash pendrives, is provided. So, the invention protects the data-storing device itself, regardless of the conditions of the computer systems it is connected to.

On the other hand, it is important to highlight that the first computing system and the second computing system can be the same one. Basically, the data-storing device can be protected in the first computing system and next it can be connected to the second computing system, the autorun file being not accessible as such a file by the operating system of said second computing system (the “autorun.inf” file is no longer considered by the operating system of any computing device as a file but as a device); or the data-storing device can be protected in the first computer system and next the data-storing device can be connected another time to the first computing system, the autorun file being not accessible as such a file by the operating system of said first computing system.

Furthermore, the operating system of the first computing system can be different from the operating system of the second computing system. Thus, for example, the operating system of the first computing system can be Microsoft Windows 98 whereas the operating system of the second computing system can be Microsoft Windows XP.

Furthermore, data associated to the autorun file can be considered metadata because it relates to data about the autorun file itself.

According to a preferred embodiment of the invention, the method further comprises:
Verifying, using the first computing system, if the autorun file is written within the data-storing device;
In case of positive result,
   Manipulating, using the first computing system, said autorun file;
   Writing, using the first computing system, a new autorun file within the data-storing device.

This way, if an autorun file exists in advance in the data-storing device, said file can be infected by malware and a new autorun file can be required. Consequently, the file can be manipulated (e.g. deleted or renamed) and a new autorun file can be written.

Alternatively, the method of the invention may comprise:
Verifying, using the first computing system, if the autorun file is written within the data-storing device;
In case of positive result,
   Overwriting, using the first computing system, the autorun file with a new autorun file.

According to another embodiment of the invention, writing data associated to the autorun file comprises modifying at least one register in which the operating system stores the properties of said file.

The data to be written in the data-storing device depends, basically, on the file system implemented in said device. During the execution of the method, it can be required determining the file system of the data-storing device, and modifying the register in which the operating system stores the properties of the autorun file according to the determined file system.

Then, for example, if the determined File System is FAT (File Allocation Table—the term FAT comprises any of FAT12, FAT16, FAT32 file systems but may apply to other file systems as well), modifying the register in which the operating system stores the properties of the autorun file may comprise modifying the file attributes byte of said autorun file with an attribute value which corresponds to a device, that is, for example, writing the value 1 in the bit 6 of said file attributes byte.

More specifically, by using the described method, a specially crafted “autorun.inf” file (due to the purposely modification of the file attributes byte) is created in the data-storing device, but this “autorun.inf” file is no longer considered by the operating system as a file but as a device (for this reason, the operating system cannot access to the autorun file as such a file). Examples of devices in a computer system are: graphic controllers, network cards, human interfaces devices, system clock, USB controllers, CD/DVD readers and writers, keyboard, processor and many more.

Since this specially crafted “autorun.inf” file is considered by the operating system as a device, any access to the same one is forbidden by the operating system. The net effect of this is that no application neither the operating system can operate with this “autorun.inf” file as such a file. It cannot be open, renamed, read, written, deleted, etc. This eliminates the possibility to create a new “autorun.inf” file that can call a malicious executable file included in the same data-storing device, avoiding then the automatic infection mechanism.

However, the autorun file may be written or not in the data-storing device in advance (before executing the method of the invention). Then,
If the autorun file exists in advance, then it is just necessary to set the bit 6 in the corresponding file attributes byte to 1 as described above;
If the autorun file does not exist in advance, then it is necessary to write at least the corresponding 32-byte entry in the directory table of the root directory. This comprises the autorun filename and the “inf” extension. Besides this, as before, the bit 6 in the corresponding file attributes byte is set to 1. The consequence of this writing is that an “autorun.inf” file is created. This can be done with a file size equal to zero, but alternatively a different file size can be written, although the file would have inconsistencies unless the File Allocation Table is properly written.

Moreover a specific content can be written inside the autorun file.

Then, the amount of data associated to the “autorun.inf” file that must be written to protect the data-storing device may vary depending on the previous existence of the “autorun.inf” file.

However, in the current implementation, if the “autorun.inf” file does not exist, an “autorun.inf” file is created with the standard CreateFile function of the Windows API using the filename. After said file is created, the bit 6 of the corresponding file attributes byte is set to 1, achieving the desired protection of the data-storing device (these two actions are equivalent to the ones described in the second point above).

Each file or directory in a FAT file system is represented by a 32-byte entry in the directory table. The entry stores the file or directory metadata: name (8 bytes), extension (3 bytes), file attributes (1 byte), date and time of creation (5 bytes), file size (4 bytes) and others.

The standard file attributes (1 byte) are archive, directory, hidden, read-only, system and volume and correspond to different bits in the byte (bits 0 to 5). One attribute that is never used in files is set by means of bit 6 (mask 0x40) and would correspond to a device.

What the invention does is to modify the file attributes byte of the autorun file (i.e. the “autorun.inf” file) with the mask 0x40. The modified file attributes byte can be obtained by applying a logical OR function between the current value of the file attributes byte and the mask 0x40; the mask 0x40 means 40 in hexadecimal notation. An alternative solution can be setting the bit 6 of the file attributes byte to 1. The following table shows possible file attributes in a FAT file system:

File Attributes

| Bit | Hex. Mask | Description |
|---|---|---|
| 0 | 0x01 | Read only |
| 1 | 0x02 | Hidden |
| 2 | 0x04 | System |
| 3 | 0x08 | Volume Label |
| 4 | 0x10 | Subdirectory |
| 5 | 0x20 | Archive |
| 6 | 0x40 | Device (internal use only, never found on disk) |
| 7 | 0x80 | Unused |

On the other hand, if the determined file system is NTFS, modifying the register in which the operating system stores the properties of the autorun file may comprise writing the number of a reserved MFT (Master File Table) entry associated to the autorun file to the INDX index of the root directory of the data-storing device. Not obviously, the implemented solution for protecting data-storing devices with a FAT file system (that is, to modify the file attributes byte of the autorun file from any value to 0x40) has not any effect in Windows NTFS current implementation.

Further, modifying the register in which the operating system stores the properties of the autorun file may also comprise writing to the reserved MFT entry associated to the autorun file data associated to said autorun file. Writing to the reserved MFT entry may also comprise writing the autorun file to said MFT entry.

But, also in this case, the autorun file may be written or not in the data-storing device in advance (before executing the method of the invention). Then,
If the “autorun.inf” file exists in advance, then it is only necessary to write in the entry associated to the “autorun.inf” file in the INDX index of the root directory, the number of the MFT entry (a number from the reserved first 16 MFT entries) allocated to the “autorun.inf” file as describe above;
If the “autorun.inf” file does not exist in advance, then a complete entry associated to an “autorun.inf” file must be created in the INDX index of the root directory and said entry must comprise the number of the MFT entry (a number from the reserved first 16 MFT entries) allocated to said “autorun.inf” file.

Moreover a specific content can be written inside the autorun file.

Then, the amount of data associated to the “autorun.inf” file that must be written to protect the data-storing device may vary depending on the previous existence of the “autorun.inf” file.

In both cases, the protection of the data-storing device is achieved, since it is not possible to create a new “autorun.inf” file. However, in the later case, it is difficult to ascertain to what extent an “autorun.inf” file has been created, since the allocated MFT entry may be void. In any case, if a file as such exists, it is a file with severe tares. More specifically, applying the described protection, it is not possible detecting from the operating system the autorun file (for example, from a tool as the Windows Explorer). However, the operating system knows the existence of the autorun file, and it is not possible to delete said file. Further, a new autorun file cannot be created.

Basically, the protection is based in using one of the reserved first 16 MFT entries associated to an autorun file. Due to the fact that files with said associated MFT entries are not accessible to any application of the operating system (e.g. Microsoft Windows), it is not possible to “see”, open, modify, or delete said files. Nor it is possible to create a file with the same name as those used in said entries.

According to a further embodiment of the invention, the method further comprises:
Verifying, using the first computing system (or any the computing system capable of executing the method according to the invention), if the content of the autorun file corresponds to a predetermined content;
In case of negative result,
   overwriting, using the first computing system, in low-level code the predetermined content of the autorun file, in the data-storing device.

It is important to highlight that the predetermined content may comprise a previously established pattern. So, it is easy to check when the pattern has been modified by a malware.

This way, a problem with some malware is solved. Said malware, when is running in a computing system and the computer program is trying to protect the data-storing device, continuously infects the data-storing device and, consequently, it is possible to protect the data-storing device while having the autorun file with malicious content inside (that for example invokes a malicious executable file). Obviously, the obtained protection is not limited because the autorun file is not parsed by the operating system even if the file is infected, but it produces problems to the user due to the fact that some antivirus programs directly access the sectors where the content of the file is stored. These antivirus programs may signal an infection detecting a malicious signature within the “autorun.inf” file.

The method of the invention, firstly, verifies if the autorun file comprises the predetermined content when the file is protected, directly accessing to the sectors where the content of the file is stored and, next, if the file does not comprise the content written by the protection, the sector where the content of the file once protected is stored is overwritten.

After the data-storing device is protected according to the method of the invention, it is possible to verify if the protection has been modified. Thus, firstly, the method verifies if the written data associated to the autorun file has been modified and, in case of positive result, the modified data is overwritten in low-level code with new data.

Basically, overwriting the data in low-level code comprises considering the volume or the entire disk as a whole, as a sequence of bytes beginning in the first byte and ending in the last byte. The volume or the disk is therefore not considered as a set of files in a file system.

The method of verifying that the protected autorun file has the predetermined content and overwriting it in low level, involve:

Opening the protected volume as a whole file.

Calculating the offset where the autorun file is located in the volume;

Accessing to that offset and reading the content of the autorun file;

Comparing its content with the predetermined content;

If both contents are not equal, accessing to the offset where the autorun file is located in the volume and writing said file with the predetermined content.

Consequently, once the autorun file is not accessible as such a file, it cannot be overwritten again by the malware.

According to a second aspect, the invention provides a computer program product comprising program instructions for causing a computing system to perform the method for protecting a data-storing device, the method comprising, when the data-storing device is connected to a first computing system:
Writing, using the first computing system, data associated to an autorun file within the data-storing device, in such a way that said autorun file is not accessible as such a file by an operating system running in a second computing system.

This way, the invention can consist in a computer program that may run in a Microsoft Windows equipped computer system. Said computer program does not access to the autorun file and its associated data by referencing it by its filename. Instead, said file and its associated data are located and written considering the volume or the entire disk as a whole, as a sequence of bytes beginning in the first byte and ending in the last byte. Then the writing of a buffer of bytes is performed from an offset from the beginning of the volume and not using any function of the Windows API that uses the filename.

For example, in FAT, if a function to change the file attributes byte pertaining to the Windows API is used (that references said file by its filename), when it is tried to set the value 0x40 as attribute of the file, the function writes 0x80 instead, since 0x40 is not a valid Windows file attributes value for a file. However, since the computer program writes directly a buffer to an offset from the beginning of the volume, it can bypass this limitation of the Windows OS.

Said computer program may be embodied on storing means (for example, on a record medium, on a computer memory or on a read-only memory) or carried on a carrier signal to be, for example, downloaded from a computer or sent by an email (for example, on an electrical or optical carrier signal).

A further embodiment of the invention comprises a method for verifying the protection of a data-storing device, the method comprising, when the data-storing device is connected to a computing system:

Obtaining, using the computing system, a univocal identifier of the data-storing device;

Verifying, using the computing system, if the obtained univocal identifier of the device is found in a data-storing device univocal identifier database;

In case of positive result,
verifying, using the computing system, if written data associated to the autorun file has been modified;
In case of positive result,
   generating, using the computing system, a warning signal about the modification.

For implementing said verification method can be required that the method for protecting a data-storing device described above further comprises:

Obtaining, using the first computing system, the univocal identifier of the data-storing device, which can be a serial number;

Sending, using the first computing system, the obtained univocal identifier to a data-storing device univocal identifier database, to be stored.

Obviously, said steps must be executed before executing the described verification method.

Mainly it is an extra functionality in which the verification method, from the identifier of the data-storing device (for example, a serial number) connected to the computing system, verifies if said identifier is comprised in a repository of data-storing identifiers that has been protected with the method of the invention. In case of positive result, the method verifies if the written data has been modified, and, in case of positive result, a warning signal is generated for alerting the user that the data-storing device has been tampered with and possibly infected.

Said extra functionality may take the form of a computer program product (which is a part of the computer program described above or is a computer program itself) comprising program instructions for causing a computing system to perform the method for verifying the protection of a data-storing device that has been protected, the method comprising, when the data-storing device is connected to a computing system:

Obtaining, using the computing system, the univocal identifier of the data-storing device;

Verifying, using the computing system, if the obtained univocal identifier of the device is found in the data-storing device univocal identifier database;

In case of positive result,
verifying, using the computing system, if written data associated to the autorun file has been modified;
In case of positive result,
   generating, using the computing system, a warning signal about the modification.

Said computer program may be embodied on storing means (for example, on a record medium, on a computer memory or on a read-only memory) or carried on a carrier signal (for example, on an electrical or optical carrier signal).

On the other hand, said extra functionality may also take the form of a system for verifying the protection of a data-storing device that has been protected according to the method for protecting a data-storing device, the system comprising:

means for obtaining the univocal identifier of the data-storing device;

means for verifying if the obtained univocal identifier of the device is found in the data-storing device univocal identifier database;

means for verifying if written data associated to the autorun file has been modified;

means for generating a warning signal about the modification.

The described system usually is part of a computing system, for instance, the first or the second computing systems described above.

According to another aspect, the invention provides a system for protecting a data-storing device, said system being comprised in a first computing system (the system can be considered part of the first computing system), the system comprising computer means for writing data associated to an autorun file within the data-storing device when the data-storing device is connected to the first computing system, in such a way that said autorun file is not accessible as such a file by an operating system running in a second computing system.

According to another aspect of the invention, it is provided a data-storing device, connectable to a computing system, comprising written data associated to an autorun file, in such a way that, when the data-storing device is connected to the computing system, the autorun file is not accessible as such a file by an operating system running in said computing system.

This way, the data-storing device is protected from malware that use the Autorun mechanism for malware propagation. The autorun file comprised in the data-storing device is not accessible by the operating system and, then, it is not possible to modify, delete, rename, etc. said file, that is, it is not possible to infect the autorun file. Obviously, neither it is possible to create a new autorun file.

According to yet another aspect, the invention provides a disk image comprising written data associated to an autorun file, in such a way that, when the disk image is restored in a data-storing device and said data-storing device is connected to a computing system, the autorun file is not accessible as such a file by an operating system running in said computing system.

In this case, it is not necessary to write data associated to the autorun file for protecting the data-storing device because the disk image itself comprises the required data for avoiding the access to the autorun file as such a file by the operating system.

The disk image can be later used to be restored in a data-storing device, thus conferring the protection against malware that use the Autorun mechanism for malware propagation to said device.

According to another aspect of the invention, it is provided a method for protecting a data-storing device, the method comprising:

Manipulating the data-storing device in such a way that, when said data-storing device is connected to a computing system, an autorun file comprised in the data-storing device is not accessible as such a file by an operating system running in said computing system.

For example it is possible to purposely manipulate a data-storing device at low level, that is, writing directly to some specific memory locations, in such a way that the effect of protection of the data-storing device against malware that use the Autorun mechanism for malware propagation can be easily achieved.

According to a further aspect, the invention provides a computer program product comprising program instructions for causing a computing system to perform the method for protecting a data-storing device, the method comprising:

Manipulating the data-storing device in such a way that, when said data-storing device is connected to a computing system, an autorun file comprised in the data-storing device is not accessible as such a file by an operating system running in said computing system.

For example, it is possible to provide a computer program that simply writes the content of a certain data file as raw data in a data-storing device. Purposely choosing the data to be written and the location in the data-storing device where the data is intended to be written, the effect of protection of the data-storing device against malware that use the Autorun mechanism for malware propagation can be easily achieved.

Said computer program may be embodied on storing means (for example, on a record medium, on a computer memory or on a read-only memory) or carried on a carrier signal (for example, on an electrical or optical carrier signal).

According to a further aspect, the invention provides a system for protecting a data-storing device, the system comprising means for manipulating the data-storing device in such a way that, when said data-storing device is connected to a computing system, an autorun file comprised in the data-storing device is not accessible as such a file by an operating system running in said computing system.

According to another aspect, the invention provides a method for blocking, to an operating system running in a first computing system, the access to at least one file, the method comprising:

Writing, using a second computing system, data associated to the file, in such a way that said file is not accessible as such a file by the operating system of the first computing system.

This way, a method for protecting the contents of files in general is obtained (the file is protected against access to its content). Because the file is not accessible as such a file by the operating system, no one can access to the contents of the file if the file is referenced by its filename.

On the other hand, it is important to highlight that the first computing system and the second computing system can be the same one.

Preferably, the method for blocking, to an operating system running in a first computing system, the access to at least one file, further comprises:

Verifying, using the first computing system, if the file is written within the data-storing device;

In case of positive result,
Manipulating, using the first computing system, said file;
Writing, using the first computing system, a new file within the data-storing device.

Alternatively, the blocking method may comprise:

Verifying, using the first computing system, if the file is written within the data-storing device;

In case of positive result,
Overwriting, using the first computing system, the file with a new file.

According to an embodiment of the invention, writing data associated to the file comprises modifying at least one register in which the operating system stores the properties of said file.

The data to be written in the data-storing device depends, basically, on the file system implemented in said device. During the execution of the method, it can be required determining the file system of the data-storing device, and modifying the register in which the operating system stores the properties of the file according to the determined file system.

Then, for example, if the determined File System is FAT, modifying the register in which the operating system stores the properties of the file may comprise modifying the file attributes byte of said file with an attribute value which corresponds to a device, that is, for example, writing the value 1 in the bit 6 of said file attributes byte.

On the other hand, if the determined file system is NTFS, modifying the register in which the operating system stores the properties of the file may comprise writing the number of a reserved MFT entry associated to the file to the INDX index of the directory of the data-storing device to which said file belongs.

Further, modifying the register in which the operating system stores the properties of the file may also comprise writing to the reserved MFT entry associated to the file data associated to said file. Writing to the reserved MFT entry may also comprise writing the file to said MFT entry.

According to yet another aspect of the invention, it is provided a computer program product comprising program instructions for causing a computing system to perform the method for blocking, to an operating system running in a first computing system, the access to at least one file, the method comprising:

Writing, using a second computing system, data associated to the file, in such a way that said file is not accessible as such a file by the operating system of the first computing system.

Said computer program may be embodied on storing means (for example, on a record medium, on a computer memory or on a read-only memory) or carried on a carrier signal (for example, on an electrical or optical carrier signal).

According to an aspect, the invention provides a system for blocking, to an operating system running in a first computing system, the access to at least one file, the system comprising means for writing, using a second computing system, data associated to the file, in such a way that said file is not accessible as such a file by the operating system of the first computing system.

According to a further aspect of the invention, it is provided a data-storing device, connectable to a computing system, comprising at least one file and data associated to said file, in such a way that, when the data-storing device is connected to the computing system, the file is not accessible as such a file by an operating system running in said computing system.

According to yet another aspect, the invention provides a disk image comprising at least one file and data associated to said file, in such a way that, when the disk image is restored in a data-storing device and said data-storing device is connected to a computing system, the file is not accessible as such a file by an operating system running in said computing system.

This way, a disk image is obtained with the file protected against access to its content.

According to a further aspect, the invention provides a method for blocking, to an operating system running in a first computing system, the access to at least one file, the method comprising:

Manipulating, using a second computing system, the data-storing device in such a way that, when said data-storing device is connected to the first computing system, the file is not accessible as such a file by the operating system of the first computing system.

According to a last aspect of the invention, it is provided a computer program product comprising program instructions for causing a computing system to perform the method for blocking, to an operating system running in a first computing system, the access to at least one file, the method comprising:

Manipulating, using a second computing system, the data-storing device in such a way that, when said data-storing device is connected to the first computing system, the file is not accessible as such a file by the operating system of the first computing system.

Said computer program may be embodied on storing means (for example, on a record medium, on a computer memory or on a read-only memory) or carried on a carrier signal (for example, on an electrical or optical carrier signal).

### DESCRIPTION OF EMBODIMENTS

In the following detailed description, two embodiments of the present invention will be described, one for a case where the supported file system by the data-storing device (for example, a pendrive) is a FAT (File Allocation Table) system (the term FAT comprises any of FAT12, FAT16, FAT32 file systems but may apply to other file systems as well), and another one where the supported file system is a NTFS (NT File System) system.

In the present described preferred embodiments, the invention is embodied in a computer program that runs in a first computing system, such as a personal computer (PC). Said PC has installed the computer program of the invention which runs, for example, in the background. After the pendrive is protected by the computer program of the invention, said protection applies for the PC in which the computer program is running or for any other computing system, for example, a further PC. In the preferred embodiments, the operating system running in the PC is Microsoft Windows XP.

Basically, the main object of the invention is to obtain a protected data-storing device (that is, the pendrive) in such a way that a Windows “autorun.inf” file comprised in it cannot act as a vector for malware propagation. To achieve this goal it is necessary writing data associated to the “autorun.inf” file in such a way that said file is not accessible as such a file by an operating system running in the computing system (for example, a Personal Computer (PC)) to which the pendrive is connected. Mainly, writing data associated to the “autorun.inf” file comprises modifying the register (or, for example, it can be more than one register in case of a NFTS file system) in which the operating system running in the PC stores the properties of said file.

In any case, firstly it is verified that a pendrive is connected to the computer to proceed with the method. Then it is verified if the pendrive comprises an “autorun.inf” file and, if the pendrive comprises an “autorun.inf” file, then the “autorun.inf” file is renamed.

Next, for writing data associated to the “autorun.inf” file it is required to determine the file system of the pendrive (that is, the written data depends on the file system of the pendrive) and modify the register in which the operating system stores the properties of the autorun file according to the determined file system. According to it, two preferred embodiments will be described.

### Example 1

### FAT File System

Following, a preferred embodiment of the invention in which the file system of the pendrive is FAT will be described.

Basically, the proposed solution consists of a computer program which may run in a Windows equipped computer system (for example, a PC). Said computer program comprises program instructions for causing the PC to perform the following method:

Verifying whether the pendrive is connected or not to the PC;

In case the pendrive is connected, verifying if its supported file system is FAT (FAT is a file system commonly used in data-storing devices as USB Pendrives);

If the file system is FAT, “creating” an “autorun.inf” file in the root directory of the pendrive with the Windows API function CreateFile using the Filename;

Setting the bit 6 of the file attributes byte to 1. This way, this attribute value corresponds to a device attribute and should not be found in a disk file (i.e., the computer program running in the PC to which the pendrive is connected must write data associated to the “autorun.inf” file in the pendrive, in such a way that said “autorun.inf” file is not accessible as such a file by the operating system running in the PC). The writing of the file attributes is not performed with a standard function that uses the filename.
Instead, the file attributes are written considering the volume or the entire disk as a whole, as a sequence of bytes beginning in the first byte and ending in the last byte. Then the writing of the file attributes byte is performed locating its offset from the beginning of the volume and not using any function of the Windows API that uses the filename.
For example, in FAT, if a function to change the file attributes byte pertaining to the Windows API is used (that references said file by its filename), when it is tried to set, for example, the value 0x40 as the file attributes of the file, the function writes 0x80 instead, since 0x40 is not a valid Windows file attributes value for a file. However, since the computer program writes directly to an offset from the beginning of the volume, it can bypass this limitation of the Windows OS.

As described above, each file or directory in a FAT file system is represented by a 32-byte entry in the directory table. The entry stores the file or directory metadata: name (8 bytes), extension (3 bytes), file attributes (1 byte), date and time of creation (5 bytes), file size (4 bytes) and others.

The standard file attributes (1 byte) are archive, directory, hidden, read-only, system and volume and correspond to different bits in the byte (bits 0 to 5). One attribute that is never used in files is set by changing bit 6 (mask 0x40) to 1 and would correspond to a device (for example, graphics controllers, processors or network cards).

Then, in the current implementation, an “autorun.inf” file is created with the standard CreateFile function of the Windows API using the filename. After said file is created, the bit 6 of the corresponding file attributes byte is set to 1, achieving the desired protection of the pendrive. Said protection is based on the fact that this file is no longer considered by the operating system running in the PC as a file but as a device, so that the operating system cannot access to the “autorun.inf” file as such a file.

This way, the computer program does not access to data associated to the autorun file by referencing it by its filename. Instead, said associated data is located and written considering the volume or the entire disk as a whole, as a sequence of bytes beginning in the first byte and ending in the last byte. Then the writing of the file attributes byte is performed locating its offset from the beginning of the volume and not using any function of the Windows API that uses the filename.

In summary, by using the described computer program, a specially crafted “autorun.inf” file (due to the purposely modification of the file attributes byte) is created in the pendrive, but this “autorun.inf” file is no longer considered by the operating system as a file, but as a device.

Since this specially crafted “autorun.inf” file is considered by the operating system “Microsoft Windows XP” as a device, any access to it is forbidden by the operating system. The effect of this is that no application, even the operating system, can operate with this “autorun.inf” file. It cannot be opened, renamed, read, written, deleted, etc. This eliminates the possibility of creating a new “autorun.inf” file which can call a malicious executable file included in the pendrive, and therefore avoiding the automatic infection mechanism.

Basically, with this method, a strong way of avoiding malware to propagate through pendrives is provided. Thus, the method of the invention protects the pendrive itself, regardless of the conditions of the systems it is connected to.

Also, the described method performed by the computer program comprises the following:

obtaining a univocal identifier (for example, the serial number) of the pendrive;

sending said obtained univocal identifier to a data-storing device univocal identifier database, to be stored.

A further specific embodiment of the invention includes another computer program or an extra functionality embedded in the previously described program, which upon detection of the connection of, for example, the protected pendrive, performs the following method for verifying the protection of the pendrive:

Obtaining the serial number (i.e. a univocal identifier) of the pendrive;

Verifying against the data-storing device univocal identifier database, which comprises the serial numbers of any protected device using the method previously described, whether the serial number of the pendrive corresponds to one which had been protected with the specially crafted “autorun.inf” file;

If the pendrive was previously protected, verifying if the special “autorun.inf” file and its associated data is still present in the pendrive. If it is present, no action is performed, and an optional information of this fact may be provided to the user;

If it was previously protected and an “autorun.inf” file with file attributes (that is, the attributes byte) different from 0x40 is found, the user is warned about the possibility of the pendrive being infected by malware. Optionally the user may be offered to perform an on-demand anti-malware scanning and also to protect again the pendrive against infection by using the previously described method.

Obviously, the pendrive can be connected in different computing systems (for example, in different PCs). The first time the pendrive (or the data-storing device in general) is connected to a computing system comprising the computer program described above, said computer program will apply the method for protecting the pendrive and the identifier of the pendrive will be sent to the internal database. When the pendrive is connected to another computing system (or to the same computing system that previously has applied the method), the “autorun.inf” file is no longer considered by the operating system (that is, one of the different versions of Microsoft Windows Operating Systems) running in the corresponding computing system as a file but as a device.

### Example 2

### NTFS File System

Since the above-mentioned modification of the register when the determined File System is FAT, is not useful in an NTFS type file. When the file system is NTFS, an alternative method is proposed.

One of the key features of the NTFS files is the Master File Table (MFT), which is a database where all the objects comprised in the NTFS File System are stored. Therefore, it is an index where the references to the clusters where each file is found in the disk are stored, plus the metadata of each file (for example, its name, date, associated directory, etc.). If a file is small enough, then its content can reside within its assigned MFT entry (register). In this case the files are known as “resident files” within the MFT. Each volume or partition of the disk has its own MFT.

The first 16 entries of the MFT are treated in a special way by NFTS and are reserved. Actually, among these 16 entries, only the 12 first ones are used, and the last 4 are reserved for future use.

The protection is based on using one of the non used and reserved entries to be associated to an “autorun.inf” file. Since the content of these MFT entries are neither visible nor accessible from the Windows applications, it is not possible to see, open, modify or erase these files. Also, it is not possible to create a file with the same name as the ones used associated to these MFT entries.

More precisely, the protection uses the last of said reserved entries. This decision has been made since it is supposed that Microsoft will use these entries in order in the future, when more enlargements are needed.

It has to be noted that the computer program of the invention, for protecting the pendrive needs to write the number of the reserved MFT entry associated to the “autorun.inf” file, to the INDX index of the root directory of the pendrive. Further, in the reserved MFT entry associated to the “autorun.inf” file, data associated to the “autorun.inf” file is written and, optionally, the “autorun.inf” file itself.

Basically, the protection is based in using one of the reserved first 16 MFT entries associated to an “autorun.inf” file. Due to the files associated to said entries are not visible from any application of the operating system, it is not possible to “see”, open, modify, or delete said files. Nor it is possible to create a file with the same name as those used in said entries.

This way, the computer program of the present embodiment performs the following:

Verifying if an “autorun.inf” file is found and in case of positive result, renaming it to maintain a copy of the original file;

Opening the volume to be protected, and reading the Boot for obtaining information of the volume;

Reading the entry MFT 15 and verifying that it is an entry of the MFT and that it is free;

Writing the number of the entry MFT 15 associated to the “autorun.inf” file, to the INDX index of the root directory of the volume.

Further, in order to maintain the file system stability, the computer program may perform the following:
Overwriting the content of the entry MFT 15 with the “autorun.inf” file and its associated data (the computer program comprises the content to be written to the entry MFT 15 embedded in the computer program itself, and, since the size of the file is small enough, it can be contained in the entry of the MFT itself).

In any case, the writing to the INDX index of the root directory or to the entry MFT 15 is performed considering the volume or the entire disk as a whole, as a sequence of bytes beginning in the first byte and ending in the last byte. Then said writing to the INDX index of the root directory or to the entry MFT 15 is performed locating its corresponding offsets from the beginning of the volume and writing two separate buffers of bytes, but not using any function of the Windows API that uses the filename.

### Example 3

### Blocking Access to a File

On the other hand, the invention also relates to a method for blocking the access to files in general, to an operating system running in a computing system such as a PC, so protecting their contents. Basically, said method comprises writing data associated to the file to be protected, in such a way that said file is not accessible as such a file by the operating system of the PC. Then, the method does not protect the volume in which the file is stored but the file or, more specifically, the content of the file. The object of the invention is to prevent the access to the contents of the file.

Said method also depends on the file system of the volume in which the file to be protected is stored.

In case of the file system is FAT, it is necessary that the computer program accesses the file attributes of the file and replaces in it the bit 6 to 1. As described above, this attribute value corresponds to a device attribute and should not be found in a disk file. Consequently, the content of the file is protected because the file is no longer considered by the operating system as a file but as a device.

In case of the file system is NTFS, it is necessary that the computer program writes the number of a reserved MFT entry associated to the file, to the INDX index of the directory of the data-storing device to which said file belongs. Further, it is also possible to write in the reserved MFT entry associated to the file, data associated to the file and, in some cases, the file itself (it depends on the size of the file to be protected). Basically, the method is based in using one of the reserved first 16 MFT entries. Consequently, the content of the file is protected because the operating system cannot access the file even though know its existence.

Obviously, all the features disclosed for an autorun file can be “applied” to a file in general.

Although the present invention has been described in detail for purpose of illustration, it is understood that such detail is solely for that purpose, and variations can be made therein by those skilled in the art without departing from the scope of the invention.

Thus, while the preferred embodiments of the methods and of the systems have been described in reference to the environment in which they were developed, they are merely illustrative of the principles of the invention. Other embodiments and configurations may be devised without departing from the scope of the appended claims.

Further, although the described embodiments of the invention comprise computer apparatus and processes performed in computer apparatus, the invention also extends to computer programs, particularly computer programs on or in a carrier, adapted for putting the invention into practice. The program may be in the form of source code, object code, a code intermediate source and object code such as in partially compiled form, or in any other form suitable for use in the implementation of the processes according to the invention. The carrier may be any entity or device capable of carrying the program.

For example, the carrier may comprise a storage medium, such as a ROM, for example a CD ROM or a semiconductor ROM, or a magnetic recording medium, for example a floppy disc or hard disk. Further, the carrier may be a transmissible carrier such as an electrical or optical signal, which may be conveyed via electrical or optical cable or by radio or other means.

When the program is embodied in a signal that may be conveyed directly by a cable or other device or means, the carrier may be constituted by such cable or other device or means.

Alternatively, the carrier may be an integrated circuit in which the program is embedded, the integrated circuit being adapted for performing, or for use in the performance of, the relevant processes.

1. A method for protecting a data-storing device, the method comprising, when the data-storing device is connected to a first computing system:
Writing, using the first computing system, data associated to an autorun file within the data-storing device, in such a way that said autorun file is not accessible as such a file by an operating system running in a second computing system.

2. A method according to claim 1, further comprising:
Verifying, using the first computing system, if the autorun file is written within the data-storing device;
In case of positive result,
Manipulating, using the first computing system, said autorun file;
Writing, using the first computing system, a new autorun file within the data-storing device.

3. A method according to claim 2, wherein manipulating the autorun file comprises deleting said file.

4. A method according to claim 2, wherein manipulating the autorun file comprises renaming said file.

5. A method according to claim 1, further comprising:
Verifying, using the first computing system, if the autorun file is written within the data-storing device;
In case of positive result,
Overwriting, using the first computing system, the autorun file with a new autorun file.

6. A method according to claim 1, wherein writing data associated to the autorun file comprises modifying at least one register in which the operating system stores the properties of said file.

7. A method according to claim 6, further comprising determining, using the first computing system, the file system of the data-storing device; and wherein modifying the register in which the operating system stores the properties of the autorun file is performed according to the determined file system.

8. A method according to claim 7, wherein the determined File System is FAT, and wherein modifying the register in which the operating system stores the properties of the autorun file comprises modifying the file attributes byte of said file with an attribute value which corresponds to a device.

9. A method according to claim 8, wherein modifying the file attributes byte of the autorun file comprises writing the value 1 in the bit 6 of said file attributes byte.

10. A method according to claim 7, wherein the determined File System is NTFS, and wherein modifying the register in which the operating system stores the properties of the autorun file comprises:
Writing the number of a reserved MFT entry associated to the autorun file, to the INDX index of the root directory of the data-storing device.

11. A method according to claim 10, wherein modifying the register in which the operating system stores the properties of the autorun file further comprises:
Writing to the reserved MFT entry associated to the autorun file, data associated to said autorun file.

12. A method according to claim 11, wherein writing to the reserved MFT entry associated to the autorun file further comprises writing the autorun file to said MFT entry.

13. A method according to claim 1, further comprising:
Obtaining, using the first computing system, a univocal identifier of the data-storing device;
Sending, using the first computing system, the obtained univocal identifier to a data-storing device univocal identifier database, to be stored.

14. A method according to claim 13, wherein the univocal identifier of the data-storing device is a serial number.

15. A method according to claim 1, further comprising:
Verifying, using the first computing system, if the content of the autorun file corresponds to a predetermined content;
In case of negative result,
overwriting, using the first computing system, in low-level code the predetermined content of the autorun file, in the data-storing device.

16. A computer program product comprising program instructions for causing a computing system to perform the method for protecting a data-storing device, the method comprising, when the data-storing device is connected to a first computing system:
Writing, using the first computing system, data associated to an autorun file within the data-storing device, in such a way that said autorun file is not accessible as such a file by an operating system running in a second computing system.

17. A computer program product according to claim 16, embodied on a storage medium.

18. A computer program product according to claim 16, carried on a carrier signal.

19. A method for verifying the protection of a data-storing device that has been protected according to the method of claim 13, the method comprising, when the data-storing device is connected to a computing system:
Obtaining, using the computing system, the univocal identifier of the data-storing device;
Verifying, using the computing system, if the obtained univocal identifier of the device is found in the data-storing device univocal identifier database;
In case of positive result,
verifying, using the computing system, if written data associated to the autorun file has been modified;
In case of positive result,
generating, using the computing system, a warning signal about the modification.

20. A computer program product comprising program instructions for causing a computing system to perform the method for verifying the protection of a data-storing device that has been protected according to the method of claim 13, the method comprising, when the data-storing device is connected to a computing system:
Obtaining, using the computing system, the univocal identifier of the data-storing device;
Verifying, using the computing system, if the obtained univocal identifier of the device is found in the data-storing device univocal identifier database;
In case of positive result,
verifying, using the computing system, if written data associated to the autorun file has been modified;
In case of positive result,
generating, using the computing system, a warning signal about the modification.

21. A system for protecting a data-storing device, said system being comprised in a first computing system, the system comprising computer means for writing data associated to an autorun file within the data-storing device when the data-storing device is connected to the first computing system, in such a way that said autorun file is not accessible as such a file by an operating system running in a second computing system.

22. A system according to claim 21, wherein the autorun file is a Windows “autorun.inf” type file.

23. A data-storing device, connectable to a computing system, comprising written data associated to an autorun file, in such a way that, when the data-storing device is connected to the computing system, the autorun file is not accessible as such a file by an operating system running in said computing system.

24. A disk image comprising written data associated to an autorun file, in such a way that, when the disk image is restored in a data-storing device and said data-storing device is connected to a computing system, the autorun file is not accessible as such a file by an operating system running in said computing system.

25. A method for protecting a data-storing device, the method comprising:
Manipulating the data-storing device in such a way that, when said data-storing device is connected to a computing system, an autorun file comprised in the data-storing device is not accessible as such a file by an operating system running in said computing system.

26. A computer program product comprising program instructions for causing a computing system to perform the method for protecting a data-storing device, the method comprising:
Manipulating the data-storing device in such a way that, when said data-storing device is connected to a computing system, an autorun file comprised in the data-storing device is not accessible as such a file by an operating system running in said computing system.

27. A method for blocking, to an operating system running in a first computing system, the access to at least one file, the method comprising:
Writing, using a second computing system, data associated to the file, in such a way that said file is not accessible as such a file by the operating system of the first computing system.

28. A computer program product comprising program instructions for causing a computing system to perform the method for blocking, to an operating system running in a first computing system, the access to at least one file, the method comprising:
Writing, using a second computing system, data associated to the file, in such a way that said file is not accessible as such a file by the operating system of the first computing system.

29. A data-storing device, connectable to a computing system, comprising at least one file and data associated to said file, in such a way that, when the data-storing device is connected to the computing system, the file is not accessible as such a file by an operating system running in said computing system.

30. A disk image comprising at least one file and data associated to said file, in such a way that, when the disk image is restored in a data-storing device and said data-storing device is connected to a computing system, the file is not accessible as such a file by an operating system running in said computing system.

31. A method for blocking, to an operating system running in a first computing system, the access to at least one file, the method comprising:
Manipulating, using a second computing system, the data-storing device in such a way that, when said data-storing device is connected to the first computing system, the file is not accessible as such a file by the operating system of the first computing system.

32. A computer program product comprising program instructions for causing a computing system to perform the method for blocking, to an operating system running in a first computing system, the access to at least one file, the method comprising:
Manipulating, using a second computing system, the data-storing device in such a way that, when said data-storing device is connected to the first computing system, the file is not accessible as such a file by the operating system of the first computing system.
